(19) United States
(12) Patent Application Publication
(10) Pub. No.: US 2025/0131798 A1
(43) Pub. Date: Apr. 24, 2025

(54) PROGRAM, METHOD, AND SYSTEM FOR GAME IN WHICH REWARD IS GIVEN TO PLAYER

(71) Applicant: CYGAMES, INC., Tokyo (JP)

(72) Inventors: Tetsuya Fukuhara, Tokyo (JP); Eisuke Odoriba, Tokyo (JP); Ryosuke Nishimura, Tokyo (JP); Kentaro Sekiguchi, Tokyo (JP); Daisuke Watanabe, Tokyo (JP); Shigeki Fujimoto, Tokyo (JP)

(73) Assignee: CYGAMES, INC., Tokyo (JP)

(21) Appl. No.: 19/005,467

(22) Filed: Dec. 30, 2024

Related U.S. Application Data
(63) Continuation of application No. PCT/JP2023/023207, filed on Jun. 22, 2023.

(30) Foreign Application Priority Data
Jun. 30, 2022 (JP) 2022-105362

(51) Int. Cl. G07F 17/32

(52) U.S. Cl. CPC G07F 17/329; G07F 17/3244

(57) ABSTRACT

Provided is a program causing a computer to execute steps for: determining, when an in-game quest is played by a player, whether the quest is cleared successfully; executing lottery processing for determining a reward to be given to the player, based on a determination result; and giving the player a reward decided through the lottery processing. The program is characterized in that the step for executing lottery processing includes: executing first lottery processing on the basis of a first lottery rate, in the case where it is determined that the quest is cleared successfully; and executing second lottery processing under a more unfavorable condition to the player than that for the first lottery processing based on a play summary evaluation decided on the basis of a play summary of the player in the quest, in the case where it is determined that the quest is not cleared successfully.

### TECHNICAL FIELD

The present invention relates to a program etc. for a game in which a reward is given to a player and, in particular, to a program etc. for executing lottery processing for deciding a reward to be given to a player on the basis of the result of a determination as to whether an item of content is cleared or not.

### BACKGROUND ART

In recent games that are electronically executed, there are known systems in which a reward acquisition rate is changed on the basis of wins and losses, such as a win, a win on points, a loss on points, and a loss, which are match results of match games, for example (Patent Literature 1).

### CITATION LIST

### Patent Literature

{PTL 1}Publication of Japanese Patent No. 6313670

### SUMMARY OF INVENTION

### Technical Problem

However, in the case where the reward acquisition rate is changed on the basis of only a win and a loss of a match game, particularly when the game is lost, even if the game is almost won or the game is hardly won, any reward that can be obtained only at the time of a win cannot be obtained. As a result, the player might lose motivation to play the game again. Furthermore, in the case where the match game is a so-called multi battle that is cooperatively performed by a plurality of players (multiple players), there is a possibility that one of the players fails, whereby all players lose the battle, and satisfactory rewards cannot be obtained. With such systems, trouble may be caused between the player who has failed and the other player(s). Furthermore, there is a risk that the player will not positively participate in a multi battle, and game play, in terms of the entire game system, might be stagnated.

The present invention has been made in order to solve such problems, and a main object thereof is to provide a program etc. in which, even in the case where an item of content such as a battle in the game fails to be cleared, a reward decided on the basis of a play summary evaluation of a player is given to the player, whereby positive play of content is encouraged.

### Solution to Problem

1. In order to achieve the above-described object, according to one aspect, the present invention provides a program causing a computer to execute: a step for determining, when in-game content is played by a player, whether the content is cleared successfully or not; a step for executing lottery processing for deciding a reward to be given to the player, on the basis of a determination result; and a step for giving the player a reward decided through the lottery processing, wherein the step for executing lottery processing comprises a step for executing first lottery processing on the basis of a first lottery rate, in the case where it is determined that the content is cleared successfully, and a step for executing second lottery processing under a more unfavorable condition to the player than that for the first lottery processing on the basis of a play summary evaluation decided on the basis of a play summary of the player in the content, in the case where it is determined that the content is not cleared successfully.

2. In the program according to Item 1, the first lottery processing may be processing for deciding whether or not to give a reward on the basis of the first lottery rate; and the second lottery processing may be processing for deciding whether or not to give a reward on the basis of a second lottery rate that is lower than the first lottery rate.

3. In the program according to Item 1 or 2, the play summary evaluation can be a content achievement rate, and the second lottery rate can be a rate obtained by multiplying the first lottery rate by the content achievement rate.

4. In the program according to one of Items 1 to 3, the content may be a battle against an enemy character, and the content achievement rate may be calculated on the basis of hit points of the enemy character and damage points given by the player to the enemy character in the content.

5. In the program according to Item 4, in the case where the battle includes a plurality of enemy characters, the step for determining, the step for executing the lottery processing, and the step for giving the reward to the player can be included for each battle against each of the enemy characters, and the hit points of the enemy character can correspond to the total hit points of the plurality of enemy characters.

6. In the program according to one of Items 1 to 5, two or more lottery slots for executing the lottery processing can be set in advance, the step for executing lottery processing can comprise a step for executing the lottery processing for each of the two or more lottery slots, and the step for giving the player a reward can comprise a step for giving a reward(s) decided in the two or more lottery slots.

7. In the program according to one of Items 1 to 6, it is also possible to further causing a computer to execute: a step for further executing third lottery processing on the basis of a play summary evaluation decided on the basis of a play summary of the player in the content, in the case where it is determined that the content is cleared successfully; and a step for giving the player a reward decided through the third lottery processing. Here, the content may be identical to or different from the content in Item 1.

8. In the program according to one of Items 1 to 7, the first lottery processing may be processing for deciding whether or not to give a reward on the basis of a lottery rate set in advance for each reward, and the second lottery processing may be processing for deciding whether or not to give a reward on the basis of a lottery rate obtained by setting a winning rate for a predetermined reward lower than the lottery rate used in the first lottery processing.

9. According to one aspect, the present invention provides a method causing a computer to execute: a step for determining, when in-game content is played by a player, whether the content is cleared successfully or not; a step for executing lottery processing for deciding a reward to be given to the player, on the basis of a determination result; and a step for giving the player a reward decided through the lottery processing, wherein the step for executing lottery processing comprises a step for executing first lottery processing on the basis of a first lottery rate, in the case where it is determined that the content is cleared successfully, and a step for executing second lottery processing under a more unfavorable condition to the player than that for the first lottery processing on the basis of a play summary evaluation decided on the basis of a play summary of the player in the content, in the case where it is determined that the content is not cleared successfully.

10. According to one aspect, the present invention provides a system that determines, when in-game content is played by a player, whether the content is cleared successfully or not, that executes lottery processing for deciding a reward to be given to the player, on the basis of a determination result, and that gives the player a reward decided through the lottery processing, wherein executing the lottery processing comprises executing first lottery processing on the basis of a first lottery rate, in the case where it is determined that the content is cleared successfully, and executing second lottery processing under a more unfavorable condition to the player than that for the first lottery processing on the basis of a play summary evaluation decided on the basis of a play summary of the player in the content, in the case where it is determined that the content is not cleared successfully.

### Advantageous Effects of Invention

According to the present invention, it is possible to provide a game in which, even in the case where in-game content could not be cleared, a reward decided on the basis of a play summary evaluation of a player is given to the player, whereby positive play of content is encouraged.

### BRIEF DESCRIPTION OF DRAWINGS

FIG. 1 is a configuration diagram of a system according to one embodiment of the present invention.

FIG. 2 is a hardware configuration diagram of the system according to the embodiment of the present invention.

FIG. 3 is a functional block diagram of the system according to the embodiment of the present invention.

FIG. 4 shows an example of lottery information according to the embodiment of the present invention.

FIG. 5 shows an example of lottery information according to the embodiment of the present invention.

FIG. 6 shows an example of lottery information according to the embodiment of the present invention.

FIG. 7 shows an example of lottery information according to the embodiment of the present invention.

FIG. 8 is a flowchart showing information processing according to the embodiment of the present invention.

FIG. 9 is a flowchart showing sub-processing according to the embodiment of the present invention.

FIG. 10 is a flowchart showing sub-processing according to the embodiment of the present invention.

FIG. 11 is a flowchart showing sub-processing according to the embodiment of the present invention.

FIG. 12 is a flowchart showing sub-processing according to the embodiment of the present invention.

FIG. 13 shows an example of a game screen according to the embodiment of the present invention.

FIG. 14 is an example of a game screen according to the embodiment of the present invention.

FIG. 15 is an example of a game screen according to the embodiment of the present invention.

### DESCRIPTION OF EMBODIMENTS

A game system 1 according to an embodiment of the present invention will be described below with reference to the drawings. In this specification, for convenience of description, there are cases where descriptions that are more detailed than necessary are omitted. For example, there are cases where detailed descriptions of matters that are already well known and repeated descriptions of substantially the same configurations are omitted.

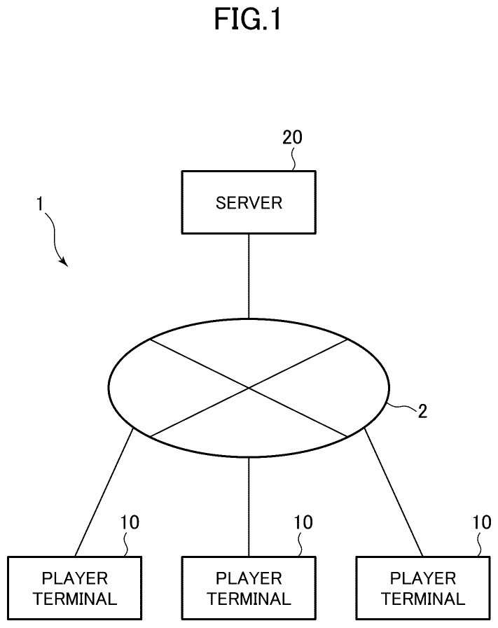

It is assumed that the game system 1 is realized by a system in which a plurality of player terminals are connected to a server via a network. FIG. 1 shows an example of the overall configuration of the game system 1 according to the embodiment of the present invention. As shown in FIG. 1, the game system 1 includes a plurality of player terminals 10 and a server 20. The player terminals 10 and the server 20 are connected to a network 2, such as the Internet, and can communicate with one another. Note that, a description will be given on the assumption that the game system 1 of this embodiment is a server-client system.

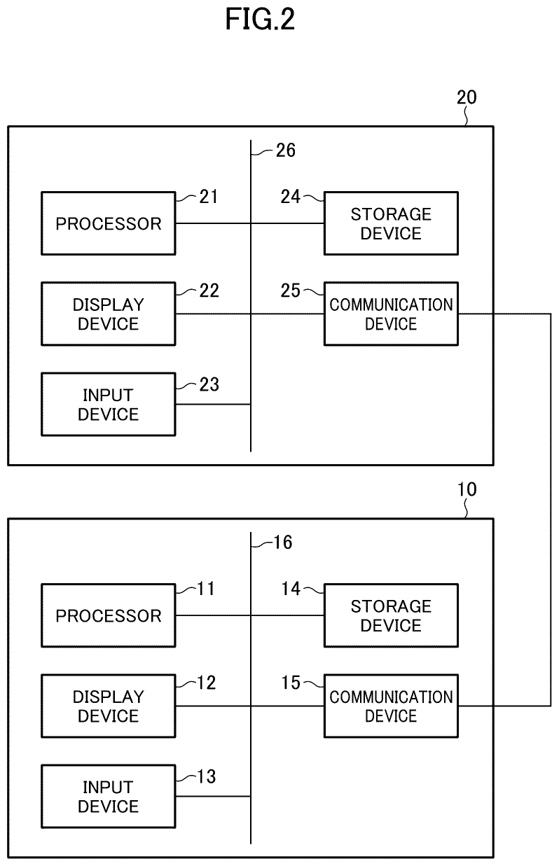

FIG. 2 is a block diagram showing hardware configurations of the server 20 and each of the player terminals 10 of the embodiment of the present invention. The player terminals 10 each include a processor 11, a display device 12, an input device 13, a storage device 14, and a communication device 15. These individual constituent devices are connected by a bus 16. Note that it is assumed that interfaces are interposed as needed between the bus 16 and the individual constituent devices. In this embodiment, the player terminals 10 are smartphones. Alternatively, the player terminals 10 can be information processing devices, such as tablet computers, personal computers, and game devices, as long as the information processing devices include the above-described configuration.

Similarly, the server 20 is also an information processing device including a processor 21, a display device 22, an input device 23, a storage device 24, and a communication device 25. These individual constituent devices are connected by a bus 26. Note that it is assumed that interfaces are interposed as needed between the bus 26 and the individual constituent devices. In this embodiment, the server 20 is realized by a computer.

The processors 11 and 21 control the overall operations of the player terminal 10 and the server 20, respectively, and are, for example, CPUs. Note that electronic circuits such as MPUs may be used as the processors 11 and 21. The processors 11 and 21 execute various kinds of processing by loading programs and data stored in the storage devices 14 and 24 and executing the programs. In one example, the processors 11 and 21 are each constituted of a plurality of processors.

The display devices (displays) 12 and 22 display application screens etc. to a user (player) of the player terminal 10 and a user (administrator) of the server 20 under the control of the processors 11 and 21, respectively. Although the display devices 12 and 22 are preferably liquid crystal displays, it is also possible to adopt displays using organic EL, plasma displays, or the like.

The input devices 13 and 23 are user interfaces for accepting inputs from the users to the player terminal 10 and the server 20 and are, for example, touchscreens, touchpads, keyboards, or mouses. In this embodiment, since the player terminal 10 is a smartphone, the player terminal 10 includes a touchscreen as the input device 13, the touchscreen also functions as the display device 12, and the display device 12 and the input device 13 have an integrated structure. It is also possible that the display device 12 and the input device 13 have separate forms disposed at different positions. Since the server 20 is a computer, it is assumed that the server 20 includes a keyboard and a mouse as the input device and includes a liquid crystal display as the display device.

The storage devices 14 and 24 are storage devices that are provided for general smartphones and computers and that include storage devices and magnetic storage devices using RAMs, which are volatile memories, and flash memories such as eMMCs, UFSs, and SSDs, which are non-volatile memories. The storage devices 14 and 24 can also include external memories. For example, the storage device 14 stores a browser program and a game program, and the storage device 24 stores a server game program. The browser program and the game program are launched in accordance with user operations with respect to the player terminal 10 and are executed on an operating system (OS) implemented in advance in the player terminal 10. The server game program includes functions and various kinds of data for performing information processing so as to properly proceed with games on the browser program and the game program executed at each player terminal serving as a client. Furthermore, databases that are physically separated from the player terminal 10 and the server 20 can be used as the storage devices.

The communication devices 15 and 25 send data to and receive data from other devices via the network 2 (not shown in FIG. 2). For example, the communication devices 15 and 25 perform mobile communication or wireless communication, such as that using a wireless LAN, to connect to the network 2. The player terminal 10 uses the communication device 15 to communicate with the server 20 via the network. The communication devices 15 and 25 may perform wired communication using an Ethernet (registered trademark) cable or the like.

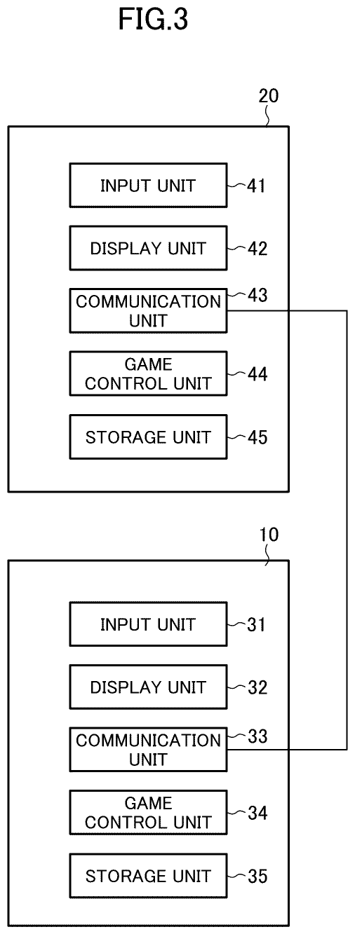

FIG. 3 shows an example of a functional block diagram of the player terminal 10 and the server 20 according to the embodiment of the present invention. The player terminal 10 includes an input unit 31, a display unit 32, a communication unit 33, a game control unit 34, and a storage unit 35. The server 20 includes an input unit 41, a display unit 42, a communication unit 43, a game control unit 44, and a storage unit 45. In this embodiment, these functions are realized when the processors 11 and 21 execute programs. For example, the executed programs are the browser program and the game program stored in the storage devices 14 and 24. Since the various kinds of functions are realized by loading the programs, as described above, a portion or the entirety of one part (function) may be included in another part. These functions may be realized by means of hardware by configuring electronic circuits or the like each realizing a portion or the entirety of each of the functions.

The input units 31 and 41 are configured by using the input devices 13 and 23, respectively, and accept inputs from the users to the player terminal 10 and the server 20. The player terminal 10 and the server 20 accept user inputs by means of the input units 31 and 41. The user inputs may include a command input indicating a command of the player in the game, for example. In this embodiment, in the player terminal 10, a touch detection function generally provided for a smartphone, which is provided with the touchscreen, can be used.

The display unit 32 of the player terminal 10 displays game screens by using the display device 12 and displays game screens in accordance with the progress of the game and user operations. The display unit 42 of the server 20 displays management screens for a game administrator, as needed, on the display device 22.

The game control units 34 and 44 perform control processing for executing the game of this embodiment and store various kinds of data required for the processing, in the storage units 35 and 45, respectively. In this embodiment, the game control unit 34 of the player terminal 10 is realized by using the browser program, and performs processing of information to be input from or output to the user, processing of signals to be sent to or received from the server 20, etc. The game control unit 34 may be realized by installing a game application in the player terminal 10.

The game control unit 44 of the server 20 is realized when the server game program is executed, and performs processing for the game executed at the player terminal 10. In one example, when the browser is launched in the player terminal 10, the game control unit 34 is realized, and the server 20 is accessed in order to proceed with the game, the game control unit 44 sends data thereto and receives data therefrom regularly or as needed, to proceed with the game. For example, the game control unit 44 stores, in the storage unit 45, various kinds of data etc. required for the control processing for executing the game of this embodiment and appropriately provides such data to the player terminal 10.

On the basis of a command received from the player terminal 10 on the basis of a player input via the communication unit 43, the game control unit 44 executes processing associated with the command. The command can include an in-game content selection command, a player-character action execution command for action in each item of content, and other commands necessary to proceed with the game.

In-game content is content included in one game and that can be played by a player. In this embodiment, it is assumed that the game is a role-playing game, and the content is a battle in which a player character fights against an enemy character, in the role-playing game. The game in the present invention is not limited to the role-playing game and can be any game as long as the game includes in-game content. The content can be, for example, any content, such as a race fight, a quiz, and a puzzle, as long as the content can be played by a player. It can be said that the content is a game in the game.

The storage units 35 and 45 are configured by using the storage devices 14 and 24, respectively. The storage unit 45 of the server 20 stores parameters of players, parameters of enemy characters, battle parameters, etc. In this embodiment, parameters of a plurality of players are stored while being linked to their respective player IDs.

The parameters of the players are stored in association with the player IDs, which are identifiers for identifying the respective players, and can include, for example, information about names, attacking powers, hit points, available abilities, possessed items, levels, possessed weapons, possessed characters, etc. of player characters operated by the players. The parameters of enemy characters are stored in association with enemy character IDs and include, for example, names, levels, attacking powers, defensive powers, hit points, etc.

The battle parameters include the parameters of an enemy character(s) and the parameters of a player(s) participating in a battle. The parameters can change when the battle progresses. For example, the hit points of the player can be decreased by an opponent's attack, and the attacking power and the defensive power thereof can be increased and decreased by special abilities. The battle can be a multi battle in which a plurality of players fight against a common enemy character in cooperation with each other. In the case of a multi battle, the parameters of a plurality of participating players are stored in association with identification information for identifying one battle. The present invention can be applied to a case of a single battle in which one player performs the battle, and, in that case, the parameters of a player who executes a battle are stored in association with identification information for identifying the battle.

The storage unit 45 further stores lottery information including a lottery rate for deciding a reward to be given to the player.

In this embodiment, when in-game content is played by a player, the game control unit 44 of the server 20 determines whether the content is cleared successfully, executes, on the basis of the determination result, lottery processing for deciding a reward to be given to the player, and gives the player the reward decided through the lottery processing. It is possible to determine that the content is cleared in the case where a certain condition for the content is achieved. The certain condition includes a case in which the hit points of an enemy character are reduced to zero or less in a fight battle, a case in which a higher order of arrival than a predetermined order is achieved in a race fight, etc. It is also possible to determine that the content is cleared in a case of a win on points and that the content is not cleared in a case of a loss on points or a draw.

In the case where it is determined that the content is cleared successfully, the lottery processing includes first lottery processing executed on the basis of a first lottery rate. In the case where it is determined that the content is not cleared successfully, the lottery processing includes second lottery processing executed under a more unfavorable condition to the player than that for the first lottery processing, on the basis of a play summary evaluation decided on the basis of the play summary in the content.

The play summary in the content may be the summary of a play decided and executed, not by player inputs, but by a program etc. executed at the server or the player terminal, that is, a so-called auto-play.

In this embodiment, the first lottery processing can be processing for deciding whether or not to give a reward, on the basis of the first lottery rate, and the second lottery processing can be processing for deciding whether or not to give a reward, on the basis of a second lottery rate that is lower than the first lottery rate. The first and second lottery processing may be processing etc. for deciding the details of a reward, such as an item, to be given.

In this embodiment, it is assumed that content means a battle. In the case where a plurality of enemy characters are included in battles, it is possible to execute, for each battle against each of the enemy characters, processing for making a determination, a step for executing lottery processing, and processing for giving a reward to the player. In this case, content that is a fight against a plurality of enemy characters and content that is a fight against each of the enemy characters can be included.

In this specification, content can include: one or more items of sub content; and an item of main content including an item(s) of sub content. For example, the whole content that includes fights against a plurality of enemy characters is referred to as main content, and content that is a fight against each enemy character is referred to as sub content, in some cases. It is determined that sub content is cleared when a fight against each enemy character is won, and it is determined that main content is cleared when fights against all enemy characters are won. In a case of a fight against one enemy character, only one item of content may be included, or main content and sub content may be included, and processing for giving a reward can be executed for each item of content.

Two or more lottery slots for executing lottery processing are set in advance, lottery processing is executed for each of the lottery slots, and a reward decided in each of the lottery slots can be given. The lottery slots can be stored in advance while being linked to each battle.

In the case where it is determined that content is cleared successfully, it is possible to further execute processing for third to fifth lottery processing and to give a reward(s) decided through the lottery processing to the player. In this embodiment, it is assumed that content is a battle played by multiple players, and a predetermined item needs to be consumed in order to generate the battle. A player who consumes the predetermined item to generate the battle is referred to as a battle generating player. Furthermore, the order of evaluations of the individual players is decided on the basis of play summary evaluations decided on the basis of the play summaries of the players during the battle.

In the third lottery processing, lottery processing is executed on the basis of a lottery rate decided on the basis of the play summary evaluation, which is decided on the basis of the play summary of each player during the battle. In the fourth lottery processing, lottery processing is executed only for the battle generating player. In the fifth lottery processing, lottery processing is executed only for a player whose evaluation order is equal to or higher than a certain order. Here, although it is assumed that the lottery processing based on the evaluation order is executed only for a player whose evaluation is in the 1st place, it is also possible to execute the lottery processing for a player whose evaluation is in the other place.

In this embodiment, in the case where it is determined that content is not cleared successfully, it is possible to further execute sixth lottery processing. The sixth lottery processing is executed only for the battle generating player, to decide whether or not to give a reward, on the basis of a sixth lottery rate lower than a fourth lottery rate.

The first and second lottery processing and the fourth and sixth lottery processing are different in that the fourth and sixth lottery processing is executed only for the content generating player but are the same in the other points. Therefore, it can be said that the fourth lottery processing and the sixth lottery processing are one embodiment of the first lottery processing and the second lottery processing to which a condition is added in which a determination as to whether the player is the content generating player is executed, and, in the case where it is determined that the player is the content generating player, the fourth lottery processing and the sixth lottery processing are executed.

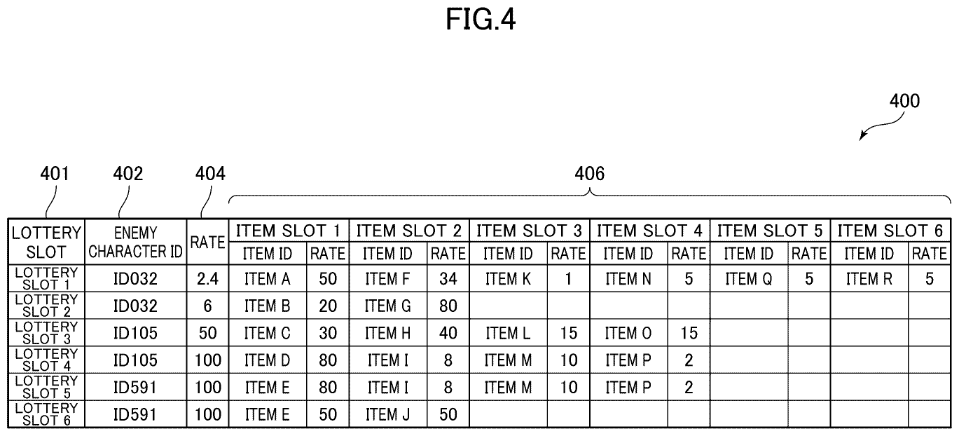

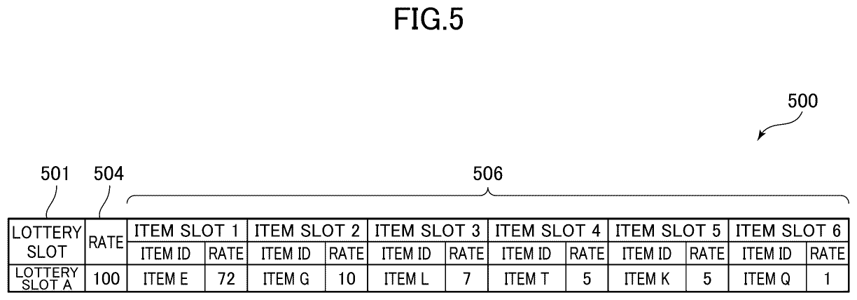

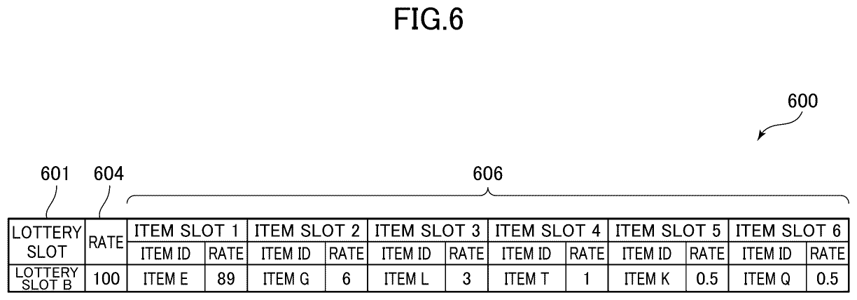

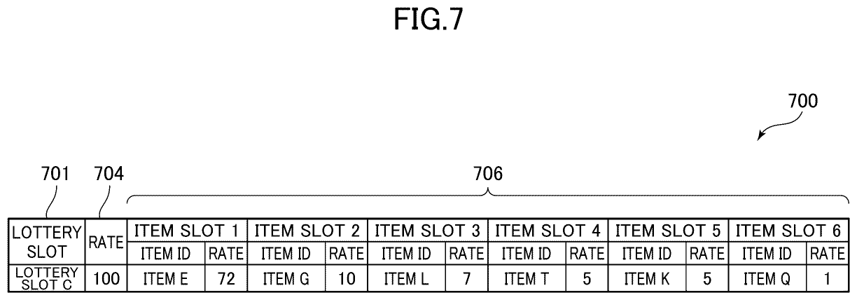

FIGS. 4 to 7 show example items of lottery information including lottery rates used in lottery processing. FIG. 4 shows first lottery information used in the first and second lottery processing, FIG. 5 shows third lottery information used in the third lottery processing, FIG. 6 shows fourth lottery information used in the fourth and sixth lottery processing, and FIG. 7 shows fifth lottery information used in the fifth lottery processing.

Although it is assumed that each item of lottery information is prepared in association with a battle, which is content, and is stored in association with a battle ID for identifying the battle, it is also possible to prepare a lottery rate common to all battles or some battles included in the game. FIG. 4 shows lottery information used in fight battles against predetermined three enemy characters. Lottery slots 1 to 6 (401) are prepared for these battles, and enemy-character identification information 402 is associated with each of the lottery slots. In FIG. 4, in the case where battles against the individual enemy characters are handled as items of content, items of lottery information corresponding to three items of content are included.

Here, the lottery slots 1 and 2 are associated with ID032, which serves as an enemy character ID, the lottery slots 3 and 4 are associated with ID105, and the lottery slots 5 and 6 are associated with ID591. In order to decide a reward for the result of a battle against each of the enemy characters, lottery processing procedures for the associated lottery slots are executed. In the case where a battle(s) against only one enemy character is included in one battle, the identification information of the one enemy character may be stored in association with the lottery slots 1 to 6, or the identification information of the enemy character associated with each of the lottery slots may be omitted.

A first lottery rate 404 and items of lottery item information in item slots 1 to 6 are set in each lottery slot 401. The first lottery rate 404 indicates a lottery rate used in lottery processing for giving a reward to the player in the lottery slot, when the battle is cleared, here, when the battle is won. The lottery rate is a winning rate. Lottery item information 406 in the item slots 1 to 6 is information for deciding an item to be given in the case where it is decided that a reward is given to the player in the corresponding lottery slot. Lottery processing is further executed on the basis of item information. An item to be given in the case where it is decided that a reward is given may also be decided in advance.

In the item information, the item slots 1 to 6 are set, and information identifying an item to be given in the case where the lottery is won and the winning rate of this item slot are shown in each of the item slots. For example, in the lottery slot 1, in the case where the battle is cleared, the rate of giving a reward in this lottery slot is 2.4%. Then, in the case where the lottery is won in this lottery slot, whereby it is decided that a reward is given, the rates of giving an item A, an item F, an item K, an item N, an item Q, and an item R are 50%, 34%, 1%, 5%, 5%, and 5%, respectively. In the lottery slot 1, in the case where the battle is cleared, the rate of giving the item A in this lottery slot is 1.2% calculated from 0.024×0.5.

The number of item slots set in each lottery slot is not limited to six. In the lottery slot 2, only two item slots 1 and 2 are set. Each item slot may include, in addition to the item ID, information indicating the number of items to be given. Furthermore, the number of items to be given may be decided by lottery processing. Furthermore, it is also possible that lottery is won in two or more item slots, and the items in the individual item slots are given.

The lottery processing for deciding whether or not to give a reward and the lottery processing for deciding an item may be executed in one lottery processing procedure. For example, it is possible that the lottery rate 404 for deciding whether or not to give a reward is not included, and a lottery for giving an item to be given is executed on the basis of the lottery rates in the items of lottery item information.

Lottery information shown in FIGS. 5 to 7 is the same as the lottery information shown in FIG. 4 in that FIG. 4 and FIGS. 5 to 7 all show lottery information for deciding a reward to be given to the player in the case where a battle is cleared, but is different from the lottery information shown in FIG. 4 in that lottery slots are not associated with enemy character IDs. Here, this is because these lottery slots are prepared in association with items of content; alternatively, the lottery slots may be stored in association with enemy character IDs. It is also possible to identify items of content by using enemy character IDs.

In this embodiment, FIGS. 5 to 7 each show a lottery slot for deciding a reward to be given to the player in the case where, even when battles against a plurality of enemy characters are included in one battle, the battles against all the enemy characters are won. That is, FIGS. 5 to 7 show lottery processing executed in the case where the main content is cleared. FIGS. 5 to 7 show information stored in association with the main content.

FIG. 5 shows a lottery slot A for the third lottery processing executed on the basis of the player's play summary in the content. FIG. 6 shows a lottery slot B for the fourth and sixth lottery processing executed only for the battle generating player. FIG. 7 shows a lottery slot C for the fifth lottery processing executed only for the player whose play summary evaluation is in the 1st place.

The entirety or a portion of the first to sixth lottery processing procedures may be executed in association with one item of content. In the case where one battle does not include any main content or sub content but includes only one item of content, or in the case where one battle includes main content and a plurality of items of sub content, the entirety or a portion of the first to sixth lottery processing procedures may be executed for the entirety or a portion of the plurality of items of sub content.

In this embodiment, although a play summary evaluation is a content achievement rate of each player, any information indicating the evaluation of the play summary may be used. Here, the content achievement rate is calculated on the basis of the maximum hit points of an enemy character and the damage points (the amount of damage dealt) the player gave to the enemy character in the content. When a plurality of enemy characters exist, the maximum hit points of the enemy character correspond to the total values of the maximum hit points of all the enemy characters. For example, the content achievement rate is calculated on the basis of the following expression.

$$Content achievement rate = {player}^{′} s amount of damage dealt / total maximum hit points of enemy character ( s ) \qquad [ Expression 1 ]$$

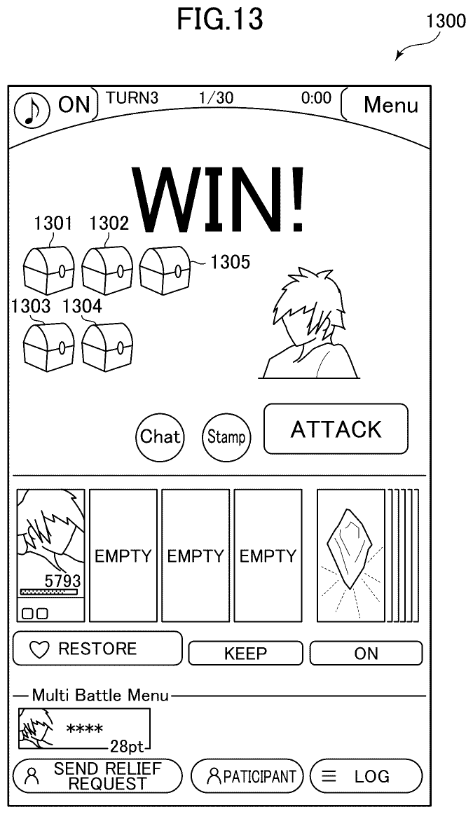

The method for deciding the content achievement rate is not limited thereto, and it is also possible to decide the content achievement rate on the basis of an ability used by the player during the battle, for example. Even when the player does not give damage to an enemy character, the content achievement rate can be increased on the basis of the use of an ability. In this case, it is possible that the total value of the content achievement rate of each player exceeds 100. It can be said that the content achievement rate used here indicates the degree of contribution of each player until the end of the content. The value calculated by multiplying the content achievement rate by 100 can be the degree of contribution. In FIGS. 13 and 15, 28 pt is a display example of the degree of contribution.

Alternatively, the play summary evaluation can be any information that can be used to evaluate the play summary; for example, parameters are set for types of actions of the player, and the total value of the parameters set for actions performed by the player is used as a player summary evaluation value.

In this embodiment, in the case where a battle is not won, the second lottery processing is executed under a more unfavorable condition to the player than that for the first lottery processing. Here, as described above, the first lottery processing includes the processing for deciding whether or not to give a reward on the basis of the first lottery rate. The second lottery processing includes the processing for deciding whether or not to give a reward on the basis of the second lottery rate, which is lower than the first lottery rate. The second lottery rate is the rate obtained by multiplying the first lottery rate by the content achievement rate. The method for deciding an item to be given, which is performed after it is decided to give a reward, is the same as in the first lottery processing.

For example, in the case where players A and B cooperate with each other in a multi battle to challenge battles including enemy characters of ID032, ID105, and ID591 but lose the battles, the content achievement rates when the battles are lost are calculated. In the case where the total value of the maximum hit points of the enemy characters is 10000, the amount of damage dealt of the player A when the battles are lost is 4000, and the amount of damage dealt of the player B is 2000, the content achievement rate of the player A is 0.4, and the content achievement rate of the player B is 0.2. In this case, the second lottery rate for the player A in the lottery slot 1 is 0.96% calculated by multiplying the first lottery rate 2.4% by 0.4, and the second lottery rate for the player B is 0.48% calculated from 2.4×0.2.

Furthermore, as one modification, in the second lottery processing, it is also possible to decide whether or not to give a reward, while using the first lottery rate as a lottery rate for a lottery slot, on the basis of a lottery rate that is obtained by setting a lottery rate for a predetermined reward lower than the lottery rate used in the first lottery processing, or it is also possible to reduce the first lottery rate and to reduce the lottery rates for rewards. In the game, an item that brings a particularly advantageous effect to the player is valuable. If such an item is made to be more easily obtained when content is cleared, the interest of the game is raised in some cases. Therefore, in the case where a battle cannot be cleared, the rate of obtaining a valuable item may be reduced.

As another modification, in the second lottery processing, it is possible to use lottery information prepared separately from lottery information used in the first lottery processing. For the second lottery processing, items of lottery information that are different depending on the content achievement rate may be referred to. For example, it is possible to prepare lottery processing information A that is used when the content achievement rate is equal to or higher than 0 and is lower than 0.3, lottery processing information B that is used when the content achievement rate is equal to or higher than 0.3 and is lower than 0.6, and lottery processing information C that is used when the content achievement rate is equal to or higher than 0.6 and is lower than 1.0, and to decide lottery processing information to be used, on the basis of the content achievement rate of each player. The lottery information for the second lottery processing just needs to have an unfavorable condition to a player compared with that for the first lottery processing.

An unfavorable condition to a player can be any condition that the rate of obtaining a reward effective for the player to play the game is reduced, such as a condition that the winning rate in a lottery slot is reduced, the lottery rate for a predetermined reward is reduced, a predetermined item is not set to a reward target, etc. Furthermore, an unfavorable condition to a player does not need to be unfavorable from every point of view. If a condition is unfavorable to a player from a certain aspect, the condition can be an unfavorable condition for a player.

The third lottery processing is lottery processing for the lottery slot A, in which lottery processing is executed on the basis of the play summary evaluation in the content. In this embodiment, it is assumed that the play summary evaluation is the content achievement rate and that the lottery processing is executed on the basis of a lottery rate calculated by multiplying the lottery rate in the lottery slot A by a coefficient decided on the basis of the content achievement rate.

As one embodiment, it is possible to use a first coefficient in the case where the content achievement rate is smaller than a first threshold, to use a second coefficient that is decided on the basis of the content achievement rate and that is larger than the first coefficient and is smaller than a third coefficient, in the case where the content achievement rate is equal to or larger than the first threshold and is smaller than a second threshold, and to use the third coefficient in the case where the content achievement rate is equal to or larger than the second threshold.

For example, it is possible to use 0.0 as the first coefficient in the case where the content achievement rate is smaller than 50%, to use the second coefficient decided by the following expression on the basis of the content achievement rate in the case where the content achievement rate is equal to or larger than 50% and is smaller than 100%, and to use 1.0 as the third coefficient in the case where the content achievement rate is 100%.

$$Second coefficient = ( third coefficient - first coefficient ) \times ( content achievement rate - first threshold ) / ( second threshold - first threshold ) + first coefficient \qquad [ Expression 2 ]$$

In the case where the content achievement rate of the player A is 70%, the second coefficient is calculated as follows: (1.0−0.5)×(70−50)/(100−50)+0.5, whereby the second coefficient is 0.7. In the case where the content achievement rate of the player B is 20%, the first coefficient of 0.0 is used, whereby the winning rate is 0%.

The coefficients used in the third lottery processing are not limited to those in this embodiment but may be decided by another method. In the first place, it is possible to directly decide lottery rates without using coefficients or to use fixed lottery rates.

The relationship between the fourth lottery processing and the sixth lottery processing is the same as the relationship between the first lottery processing and the second lottery processing. The sixth lottery processing can be processing for deciding whether or not to give a reward on the basis of a sixth lottery rate lower than the fourth lottery rate, in the case where content is not cleared. Here, as shown in FIG. 6, the rate of giving a reward in the fourth lottery processing is 100%, and, in the sixth lottery processing, lottery processing is executed by using a lottery rate calculated by multiplying the fourth lottery rate by the content achievement rate, as in the second lottery processing.

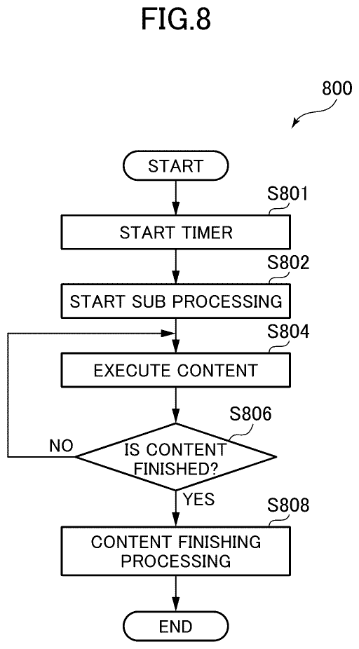

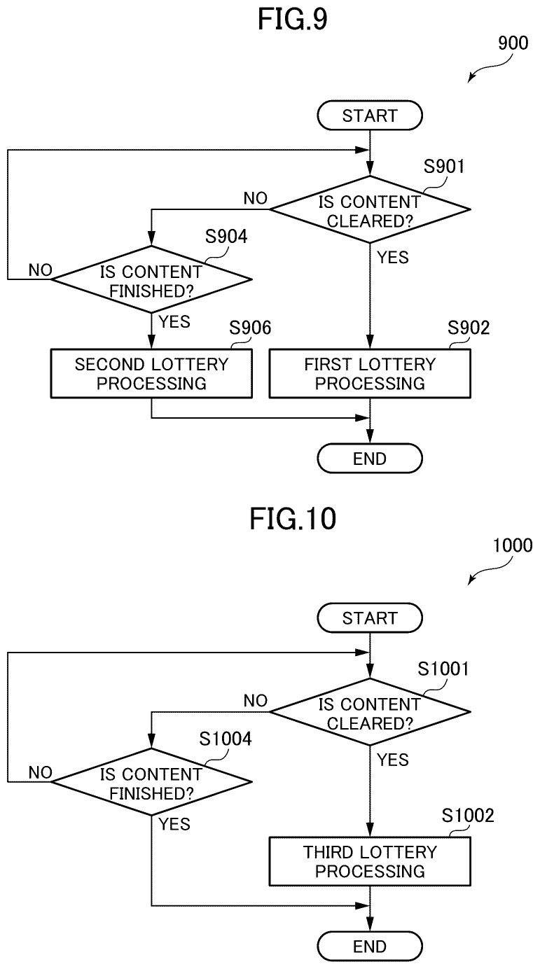

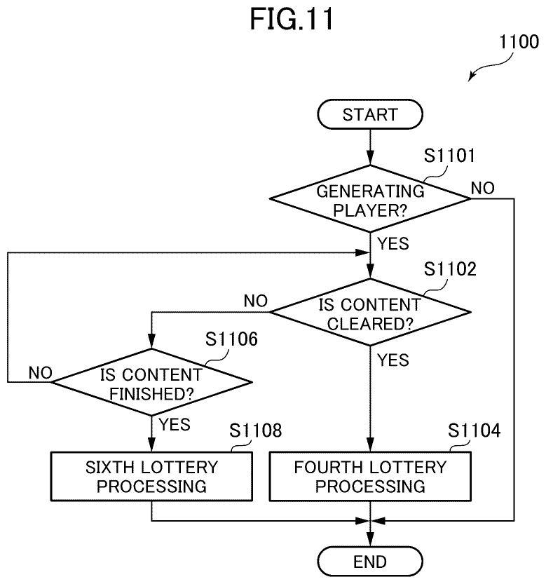

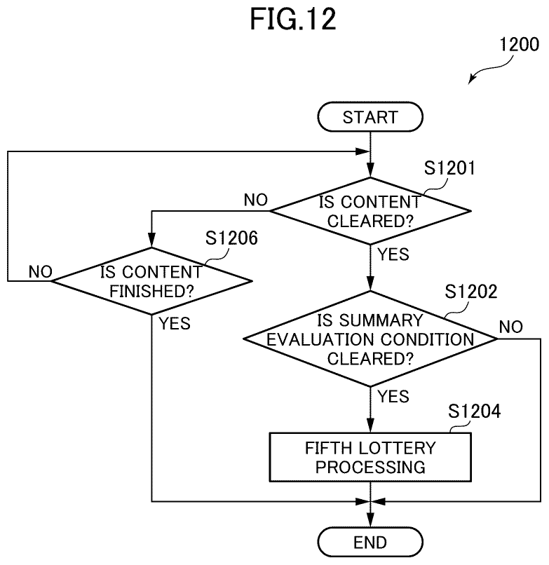

Next, information processing executed in the game system 1 of the embodiment of the present invention will be described by using a flowchart shown in FIG. 8. It is assumed that the player plays a role-playing game to make a story progress while performing a fight battle against an enemy character. When a player input for performing, as content in the role-playing game, a fight battle against an enemy character is performed, the server 20 starts main processing 800 for the fight battle selected on the basis of the player input.

Here, main content for reducing the hit points of all three enemy characters to zero or less and three items of sub content for reducing the hit points of the individual enemy characters to zero or less are included. Each item of content has to be finished within a specified period, and, if the hit points of any of the enemy characters are larger than zero even after the specified period has passed, it is determined that the content is not cleared due to timeout. In the case where the hit points of the player character are reduced to zero or less, it is also determined that the content is not cleared.

When the main processing 800 for executing content that is a fight battle is started, first, a timer is started (S801), and execution of sub processing is started (S802). The timer is used to determine timeout. In the case where timeout determination is not performed, the timer is not necessary. The sub processing is processing executed in parallel with the main processing 800.

The sub processing is processing for executing each lottery on the basis of clear determination and finish determination of the corresponding content. Therefore, the sub processing is executed for each lottery processing executed on the basis of clear determination of the content. One sub processing procedure is executed for lottery processing procedures any one of which is executed on the basis of whether the content is cleared or not, as in the first and second lottery processing and the fourth and sixth lottery processing. Note that the entirety or a portion of sub processing can also be incorporated into the main processing and executed.

Here, parallel execution of three sub processing procedures 900 is started for the first and second lottery processing executed for the three enemy characters. Furthermore, sub processing 1000 for the third lottery processing, sub processing 1100 for the fourth and sixth lottery processing, and sub processing 1200 for the fifth lottery processing, these lottery processing procedures being executed in accordance with the success or failure in clearing the main content, are executed one by one.

In sub processing, content that is a target of clear determination and finish determination is content associated with the lottery processing in the sub processing. In the case where main content and items of sub content have a relationship in which, when the main content is finished, the items of sub content are also finished, the finish of content can be determined from the fact that the main content is finished. Here, it is determined whether the main content is finished or not. When the main content is finished, it can be determined that the items of sub content are all finished. It is assumed that the content in the main processing 800 means the main content. As one modification, the sub processing procedures 1000, 1100, and 1200 may be collectively executed when the main content is finished.

In the case where there is only one item of content, the content in the sub processing matches the content in the main processing. For example, it is determined that content is cleared only in the case where there is one enemy character or in the case where three enemy characters are all defeated, and the sub processing is executed only for this content. At this time, clear determination and finish determination are performed on the basis of whether one or three enemy characters are all defeated or not.

Then, in the main processing 800, entity processing for the content is executed. The entity processing for the content is different for each item of content. Here, it is assumed that a fight battle in which a player character and an enemy character(s) perform a turn-based battle is executed. In content execution processing (S804), a player input for one turn is accepted, an action of the player character is decided, an action of the enemy character(s) is further decided, the hit points of the player character and the hit points of the enemy character(s) are calculated on the basis of the decided actions of the player character and the enemy character(s), production screen information is generated, and a production screen is displayed on the display unit 32 of the player terminal 10. In the case of a multi battle, the battle parameters are sequentially updated on the basis of an input of another player.

Next, the game control unit 44 determines whether the content is finished (S806). In the case where the calculated hit points of the player character become zero or less, in the case where the timer exceeds the time limit, or in the case where the hit points of the all enemy character(s) in the content become zero or less, it is determined that the content is finished. In addition, it can be determined that the content is finished on the basis of a certain condition.

In parallel with these processing procedures, whether the content is cleared or not and whether the content is finished or not are monitored in each of the sub processing procedures. The sub processing 900 will be described below. In S901, it is determined whether the content is cleared or not. That is, it is determined whether the hit points of the enemy character in the battle, which is the content monitored in this sub processing, become zero or less. Here, three enemy characters are included in the main content, and a battle that is the content monitored in each sub processing 900 is a battle against one of the three enemy characters. Therefore, three sub processing procedures 900 are executed in parallel, and it is determined whether the hit points of one enemy character in the battle monitored in each of the sub processing procedures 900 become zero or less.

In the case where it is determined that the content is cleared, the first lottery processing is executed (S902). Here, it is assumed that the content associated with the lottery information shown in FIG. 4 is executed, and the lottery processing for lottery slots associated with the battle against the enemy character, the battle being monitored in this sub processing, is executed. For example, in the case where the enemy character ID is ID032, lottery processing for the lottery slots 1 and 2 is executed. Whether or not to give a reward is decided at a winning rate (lottery rate) of 2.4% on the basis of the lottery processing for the lottery slot 1. In the case where it is decided to give a reward, lottery processing for deciding which of the item slots 1 to 6 is won is executed on the basis of the lottery rates of the individual item slots shown in FIG. 4. When it is decided to give a reward and when a reward item to be given is decided, a screen display indicating giving of the reward is displayed on the display unit 32 of the player terminal 10.

In the case where it is determined that the content is not cleared in S901, it is determined whether the content is finished or not (S904). Here, a case in which it is determined that the content is finished corresponds to a case in which the content is not cleared. In the case where the content is finished without being cleared, the second lottery processing is executed (S906).

The second lottery processing is executed under a more unfavorable condition to the player than that for the first lottery processing. Here, lottery processing is executed on the basis of the rate obtained by multiplying the lottery rate for the first lottery processing by the content achievement rate. The content achievement rate is sequentially calculated on the basis of player inputs during the content execution processing (S804).

In S904, in the case where it is determined that the content is not finished, the flow returns to S901, and the sub processing 900 is repeatedly executed.

In the sub processing 1000, in the case where the content is cleared, the third lottery processing is executed on the basis of the lottery rate decided on the basis of the play summary evaluation, which is decided on the basis of the play summary of each player during the content. Here, the content is a fight against all the three enemy characters, and whether the content is cleared or not is determined on the basis of whether the hit points of all the three enemy characters could be reduced to zero or less (S1001).

In the case where it is determined that the content is cleared, the third lottery processing is executed (S1002). As lottery information used for the third lottery, that in the lottery slot A, shown in FIG. 5, is used. The lottery processing is executed on the basis of the rate obtained by multiplying the lottery rate shown in FIG. 5 by a coefficient decided on the basis of the content achievement rate.

In the case where it is determined that the content is not cleared, and it is determined that the content is not finished (S1004), the flow returns to the content clear determination (S1001), and the sub processing 1000 is repeatedly executed. In the case where it is determined that the content is finished, the sub processing is ended.

In the sub processing 1100, the fourth lottery processing and the sixth lottery processing are executed, which are executed only for the content generating player. The content associated with the lottery processing is the fight against all the three enemy characters as in the third lottery processing. First, in S1101, it is determined whether the player is the content generating player or not. Whether the player is the content generating player or not can be determined, for example, by including the player ID of the battle generating player in the battle parameters. If the player is not the content generating player, the sub processing 1100 is ended.

In the case where it is determined that the player is the content generating player, whether the content is cleared or not is determined (S1102). In the case where it is determined that the content is cleared, lottery processing is executed by using the lottery information in the lottery slot B shown in FIG. 6 (S1104). In the case where it is determined that the content is not cleared and it is determined that the content is not finished (S1106), the flow returns to the content clear determination processing (S1102), and the sub processing 1100 is repeatedly executed. In the case where it is determined that the content is finished without being cleared, the sixth lottery processing is executed. In the sixth lottery processing, lottery processing is executed on the basis of the lottery rate calculated by multiplying the lottery rate in the lottery information for the fourth lottery processing by the content achievement rate.

In sub processing 1200, the fifth lottery processing is executed, which is executed only for the player whose play summary evaluation is in the 1st place. The lottery processing is executed on the basis of the lottery slot C, shown in FIG. 7. The content associated with the lottery processing is the fight against all the three enemy characters as in the third lottery processing. It is determined whether the content is cleared or not (S1201), and, in the case where it is determined that the content is cleared, it is determined whether a player summary evaluation condition for executing the fifth lottery processing is satisfied or not (S1202). Here, it is determined whether the play summary evaluation of the player is in the 1st place or not.

In the case where it is determined that the player summary evaluation of the player is in the 1st place, the fifth lottery processing is executed (S1204). As lottery information for the fifth lottery, that in the lottery slot C, shown in FIG. 7, is used.

In the case where it is determined that the play summary evaluation of the player does not satisfy the player summary evaluation condition for executing the fifth lottery processing, the sub processing 1200 is ended without executing the fifth lottery processing. In the case where it is determined that the content is not cleared and that the content is finished (S1206), the sub processing 1200 is ended without executing the lottery processing. In the case where the content is not finished, the flow returns to the processing for determining whether the content is cleared or not (S1201), and the sub processing 1200 is repeatedly executed.

In the main processing 800, when it is determined that the content is finished (S806), content finishing processing is executed (S808). In the content finishing processing, production screen information based on the individual lottery results is generated, and a production screen is displayed on the display unit 32 of the player terminal 10. Then, the whole content is finished, and the processing is returned to the main role-playing game, which has called the content. The content execution S804 is repeatedly executed until it is determined that the content is finished.

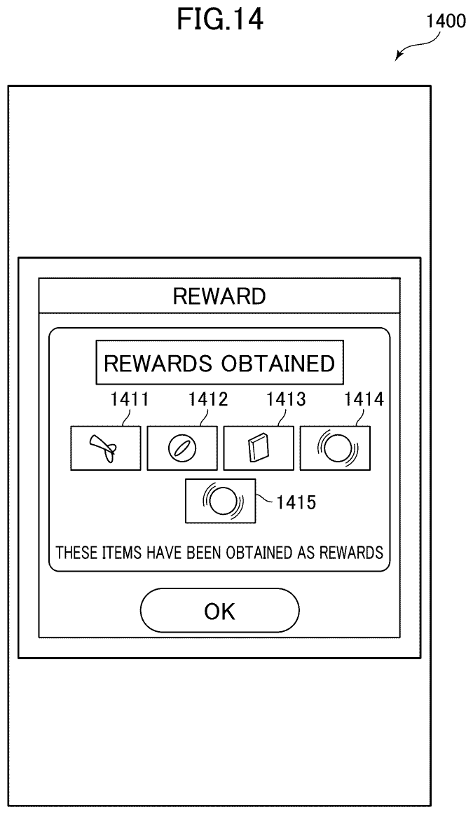

FIG. 13 shows an example of a production screen 1300 displayed in the case where the three items of sub content are cleared, and the item of main content is cleared and finished. Here, although an example case in which the number of players is one is shown, in the case where a plurality of players participate therein, it is also possible to show a display indicating the other player(s) and to show the degree of contribution of the other player(s). Treasure box images 1301 to 1305 are shown, which indicate that rewards of the lottery slot B and the lottery slots 3 to 6 for each of which it is decided to give a reward in the first lottery processing have been given. FIG. 14 shows an example of a production screen 1400 showing reward items displayed on the basis of a subsequent player's operation input for making a screen transition. Items of information 1411 to 1415 indicating items won in the lottery slots 3 to 6 and the lottery slot B are displayed.

Content that is a target of clear determination for the third to sixth lottery processing may be the same as content that is a target of clear determination for the first and second lottery processing.

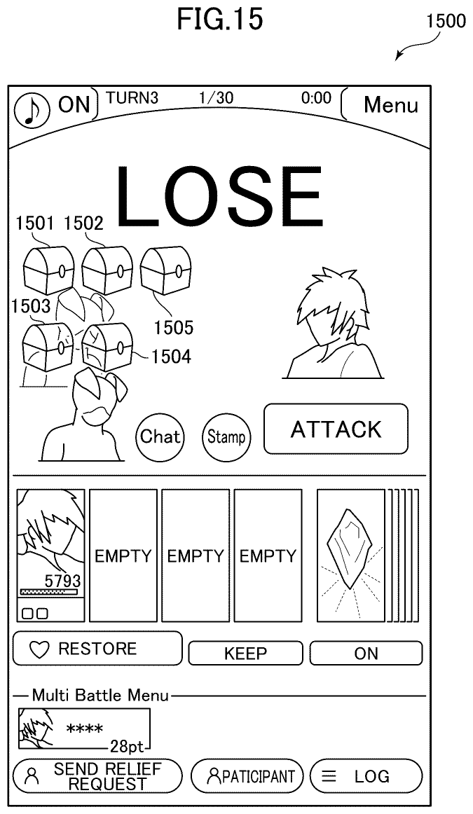

FIG. 15 shows an example of a production screen 1500 displayed in the case where one item of sub content is cleared, and the main content is finished without being cleared. Since a first item of sub content is cleared, the first lottery processing is executed for the first item of sub content. Since second and third items of sub content could not be cleared, the second lottery processing is executed for these items of sub content. Since the main content could not be cleared, the sixth lottery processing is executed. As a result, as in FIG. 13, the case in which the lottery slots 3 to 6 and the lottery slot B are won is shown. Since rewards are obtained also in this case, the screen is transitioned, and a screen showing obtained items, as in FIG. 14, is displayed. It is also possible to display obtained items and to display the content achievement rate, the degree of contribution, the lottery rates used for the lotteries, etc.

Here, although the lottery processing for the lottery slots A and C is executed only in the case where the main content of the whole battle against a plurality of enemy characters is cleared, that is, in the case where all the enemy characters are defeated, it is also possible that lottery processing is executed at the lottery rate obtained by multiplying the lottery rate for the third and fifth lottery processing by the content achievement rate, as in the lottery slot B.

By using this embodiment, even in the case where content is finished without being cleared, a reward is given on the basis of a player's play summary evaluation, thereby making it possible to provide a player with a stronger motivation to play the content. However, if a reward is given in the same condition as in the case where the content is cleared, a motivation to clear the content may be reduced. Thus, lottery processing is executed under a more unfavorable condition to the player than that in the case where the content is cleared. Here, an unfavorable condition is decided on the basis of the content achievement rate, whereby a motive to take the best measure in order to clear the content is given while the content is being played, which leads to activation of the play. In particular, in a case of a multi play, it is possible to encourage all players to play the content so as to be able to obtain higher content achievement rates.

In the above-described processing or operation, the processing, operation, or processing entity can be modified freely as long as no inconsistency arises in the processing or operation, such as an inconsistency that a certain step utilizes data that may not yet be available in that step. Furthermore, the examples described above are examples for explaining the present invention, and the present invention is not limited to those examples. The present invention can be embodied in various forms as long as there is no departure from the gist thereof.

### REFERENCE SIGNS LIST

1: game system, 10: player terminal, 11: processor, 12: display device, 13: input device, 14: storage device, 15: communication device, 16: bus, 20: server, 21: processor, 22: display device, 23: input device, 24: storage device, 25: communication device, 26: bus, 31: input unit, 32: display unit, 33: communication unit, 34: game control unit, 35: storage unit, 41: input unit, 42: display unit, 43: communication unit, 44: game control unit, 45: storage unit, 800: main processing, 900: sub processing, 1000: sub processing, 1100: sub processing, 1200: sub processing

1. A non-transitory computer readable medium storing a program causing a computer to execute:
a step for determining, when in-game content is played by a player, whether the content is cleared successfully or not;
a step for executing lottery processing for deciding a reward to be given to the player, on the basis of a determination result; and
a step for giving the player a reward decided through the lottery processing,
the program being characterized in that the step for executing lottery processing comprises
a step for executing first lottery processing on the basis of a first lottery rate, in the case where it is determined that the content is cleared successfully, and
a step for executing second lottery processing under a more unfavorable condition to the player than that for the first lottery processing on the basis of a play summary evaluation decided on the basis of a play summary of the player in the content, in the case where it is determined that the content is not cleared successfully.

2. The non-transitory computer readable medium storing a program according to claim 1, characterized in that:
the first lottery processing is processing for deciding whether or not to give a reward on the basis of the first lottery rate; and
the second lottery processing is processing for deciding whether or not to give a reward on the basis of a second lottery rate that is lower than the first lottery rate.

3. The non-transitory computer readable medium storing a program according to claim 2, characterized in that:
the play summary evaluation is a content achievement rate; and
the second lottery rate is a rate obtained by multiplying the first lottery rate by the content achievement rate.

4. The non-transitory computer readable medium storing a program according to claim 3, characterized in that:
the content is a battle against an enemy character; and
the content achievement rate is calculated on the basis of hit points of the enemy character and damage points given by the player to the enemy character in the content.

5. The non-transitory computer readable medium storing a program according to claim 4, characterized in that:
in the case where the battle includes a plurality of enemy characters, the step for determining, the step for executing the lottery processing, and the step for giving the reward to the player are included for each battle against each of the enemy characters; and
the hit points of the enemy character correspond to the total hit points of the plurality of enemy characters.

6. The non-transitory computer readable medium storing a program according to claim 1, characterized in that:
two or more lottery slots for executing the lottery processing are set in advance;
the step for executing lottery processing comprises a step for executing the lottery processing for each of the two or more lottery slots; and
the step for giving the player a reward comprises a step for giving a reward(s) decided in the two or more lottery slots.

7. The non-transitory computer readable medium storing a program according to claim 1, characterized by further causing a computer to execute:
a step for further executing third lottery processing on the basis of a play summary evaluation decided on the basis of a play summary of the player in the content, in the case where it is determined that the content is cleared successfully; and
a step for giving the player a reward decided through the third lottery processing.

8. The non-transitory computer readable medium storing a program according to claim 1, characterized in that:
the first lottery processing is processing for deciding whether or not to give a reward on the basis of a lottery rate set in advance for each reward; and
the second lottery processing is processing for deciding whether or not to give a reward on the basis of a lottery rate obtained by setting a winning rate for a predetermined reward lower than the lottery rate used in the first lottery processing.

9. A method causing a computer to execute:
a step for determining, when in-game content is played by a player, whether the content is cleared successfully or not;
a step for executing lottery processing for deciding a reward to be given to the player, on the basis of a determination result; and
a step for giving the player a reward decided through the lottery processing,
wherein the step for executing lottery processing comprises
a step for executing first lottery processing on the basis of a first lottery rate, in the case where it is determined that the content is cleared successfully, and
a step for executing second lottery processing under a more unfavorable condition to the player than that for the first lottery processing on the basis of a play summary evaluation decided on the basis of a play summary of the player in the content, in the case where it is determined that the content is not cleared successfully.

10. A system that
determines, when in-game content is played by a player, whether the content is cleared successfully or not;
executes lottery processing for deciding a reward to be given to the player, on the basis of a determination result; and
gives the player a reward decided through the lottery processing,
the system being characterized in that executing the lottery processing comprises
executing first lottery processing on the basis of a first lottery rate, in the case where it is determined that the content is cleared successfully, and
executing second lottery processing under a more unfavorable condition to the player than that for the first lottery processing on the basis of a play summary evaluation decided on the basis of a play summary of the player in the content, in the case where it is determined that the content is not cleared successfully.
